(19) United States
(12) Patent Application Publication
(10) Pub. No.: US 2013/0174151 A1
(43) Pub. Date: Jul. 4, 2013

(54) INFORMATION PROCESSING APPARATUS AND METHOD OF CONTROLLING VIRTUAL MACHINE

(71) Applicant: Hiroshi Nakajima, Nishitokyo-shi (JP)

(72) Inventor: Hiroshi Nakajima, Nishitokyo-shi (JP)

(21) Appl. No.: 13/608,378

(22) Filed: Sep. 10, 2012

(30) Foreign Application Priority Data
Dec. 28, 2011 (JP) 2011-288105

(51) Int. Cl. G06F 9/455

(52) U.S. Cl. 718/1

(57) ABSTRACT

According to one embodiment, an apparatus includes a controller. The controller is configured to control an operation environment of a virtual machine which runs on a hypervisor. The controller includes a change module configured to change the virtual machine from an operating state to a sleep state, in response to a logout request for an operating system in the virtual machine, a storing module configured to store first image data indicating contents of a memory in a storage as an operation environment, a restoration module configured to restore the contents of the memory to contents based on second image data, and a return module configured to return the virtual machine to the operating state after the contents of the memory is restored to the contents based on the second image data.

### CROSS-REFERENCE TO RELATED APPLICATIONS

This application is based upon and claims the benefit of priority from Japanese Patent Application No. 2011-288105, filed Dec. 28, 2011, the entire contents of which are incorporated herein by reference.

### FIELD

Embodiments described herein relate generally to an information processing apparatus and a method of controlling a virtual machine, in which a virtual machine is performed on a hypervisor.

### BACKGROUND

There exist thin-client systems, in which a number of people can use the same OS and application environment from any client without specifying places. A thin-client system is realized by transmitting picture information executed on a server to each client, and displaying the picture information on each client. Input information input by keys and a mouse is transmitted from a client to the server, and executed by the server.

Although the method of transferring picture information can be comfortably used in an environment in which there are sufficient network bands and there are small delays. When such an environment is not secured, however, the method has defects of slow response to operation, and low operability.

There is a method of solving the above defects of thin-client systems, by distributing a disk image of an execution environment to each client and virtualizing the image in the client, to use the same OS and application environment by a plurality of people and from any client, like thin-client systems.

In prior art, in a method of executing a virtual machine on the thin-client side, hardware (dedicated hardware to virtualize the I/O, such as VT-d manufactured by Intel Corporation) which can simultaneously execute a plurality of virtual machines is required to use virtual machines of a plurality of user environments by turns in one client computer. When there is no such hardware, the device I/O is realized by emulation by software, and performance of the I/O is low. To use the I/O by a plurality of virtual machines in a method of directly accessing one I/O, it is necessary to restart and switch the virtual machines, and a wait time required until the virtual machine can be used is long.

It is required to reduce the wait time required until the virtual machine can be used when virtual machines are switched, in a method of directly accessing the I/O, without degrading the I/O performance.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram illustrating an example of a system configuration of an embodiment.

FIG. 2 is an exemplary block diagram illustrating an example of a software configuration of a client computer.

FIG. 3 is an exemplary block diagram illustrating an example of a structure of a virtual disk.

FIG. 4 is an exemplary diagram used for explaining a structure and operation of the client computer in a setup mode.

FIG. 5 is an exemplary diagram used for explaining a structure and operation of the client compute before login.

FIG. 6 is an exemplary diagram used for explaining a structure and operation of the client computer when login is performed by the user.

FIG. 7 is an exemplary diagram used for explaining a structure and operation of the client computer when the login user is switched.

FIG. 8 is an exemplary diagram illustrating an example of change of the state of a virtual machine manager.

FIG. 9 is an exemplary flowchart illustrating an example of operation of a management agent.

FIG. 10 is an exemplary sequence diagram for explaining operation of the whole system.

FIG. 11 is an exemplary sequence diagram for explaining operation of the whole system.

FIG. 12 is an exemplary sequence diagram for explaining operation of the whole system.

FIG. 13 is an exemplary sequence diagram for explaining operation of the whole system.

FIG. 14 is an exemplary diagram used for explaining preparation of difference data of data in a memory.

### DETAILED DESCRIPTION

Various embodiments will be described hereinafter with reference to the accompanying drawings.

In general, according to one embodiment, an information processing apparatus includes a memory and a controller. The controller is configured to control an operation environment of a virtual machine which runs on a hypervisor. The controller includes a change module, a storing module, a restoration module, and a return module. The change module is configured to change the virtual machine from an operating state to a sleep state, in response to a logout request for an operating system in the virtual machine. The storing module is configured to store first image data indicating contents of the memory used by the operating system in a nonvolatile storage device as an operation environment corresponding to a first user who logged into the operating system. The restoration module is configured to restore the contents of the memory to contents based on second image data indicating a second operation environment corresponding to a second user. The second image data is stored in the nonvolatile storage device, when there is a user change request from the first user to the second user. The return module is configured to return the virtual machine to the operating state after the contents of the memory is restored to the contents based on the second image data.

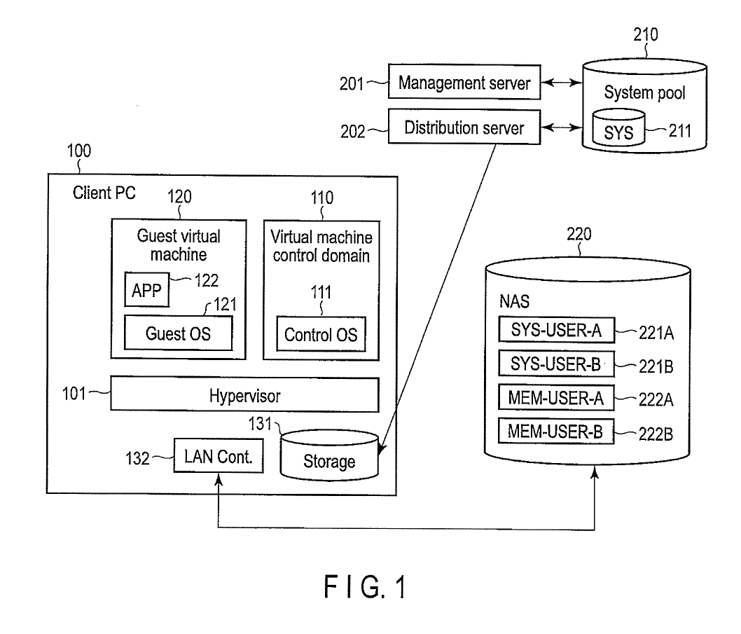

FIG. 1 is a block diagram of a system configuration.

The system comprises a client computer (client PC) 100, a management server 201, a distribution server 202, and network attached storage (NAS) 220, and the like.

A system pool 210 is connected to the management server 201 and the distribution server 202. A disk image file of a guest virtual machine is stored in the system pool 210. The disk image file is transferred to the client computer through the distribution server 202. The management server 201 performs management and setting of disk image files which correspond to respective clients.

In the client computer 100, hardware is virtualized by a hypervisor (virtualization software) 101, and a plurality of virtual machines run on the hypervisor 101. In the system, a guest virtual machine (desktop OS, application) and a virtual machine controlling OS of a virtual machine control domain are simultaneously run.

Storage (HDD or SSD) 131 in the client computer 100 stores a disk image file which is distributed from the distribution server 202. The file server (NAS) 220 is connected to a network which is connected to a LAN controller 132. The file server (NAS) 220 stores data and setting values of applications updated by the users.

The NAS 220 stores a SYS-USER-A file 221A, a SYS-USER-B file 221B, a MEM-USER-A file 222A, and a MEM-USER-B file 222B. The SYS-USER-A file 221A and the MEM-USER-A file 222A are files to reproduce a usage environment of user A of a guest virtual machine 120. The SYS-USER-B file 221B and the MEM-USER-B file 222B are files to reproduce a usage environment of user B of the guest virtual machine 120. According to the user who uses the client computer, the SYS-USER-A file 221A and the MEM-USER-A file 222A, or the SYS-USER-B file 221B and the MEM-USER-B file 222B, are transferred to the client computer 100.

Although there are some methods of virtualizing the I/O device, the I/O device is virtualized in the present system by using a pass-through model. In a pass-through model, the virtual machine monitor can directly assign the I/O device to the virtual machine. For example, dedicated SCSI cards or network cards are prepared for respective virtual machines, and they are assigned to the virtual machines one by one. A device manager controls initialization of a PCI device.

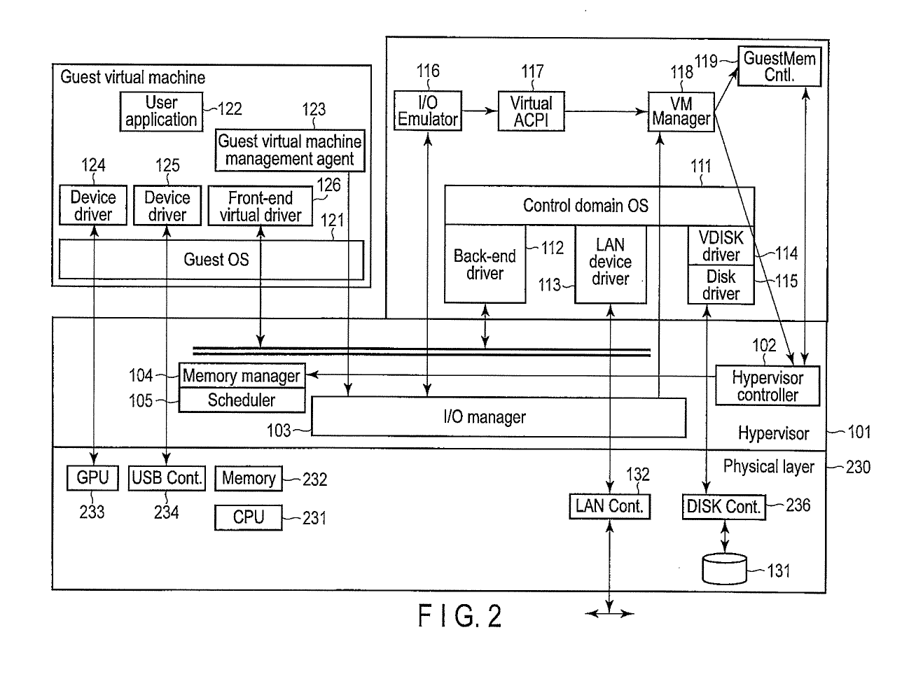

Next, software configuration of the client computer 100 will be explained hereinafter, with reference to FIG. 2.

The virtual machine control domain 110 and the guest virtual machine 120 operate on the hypervisor 101.

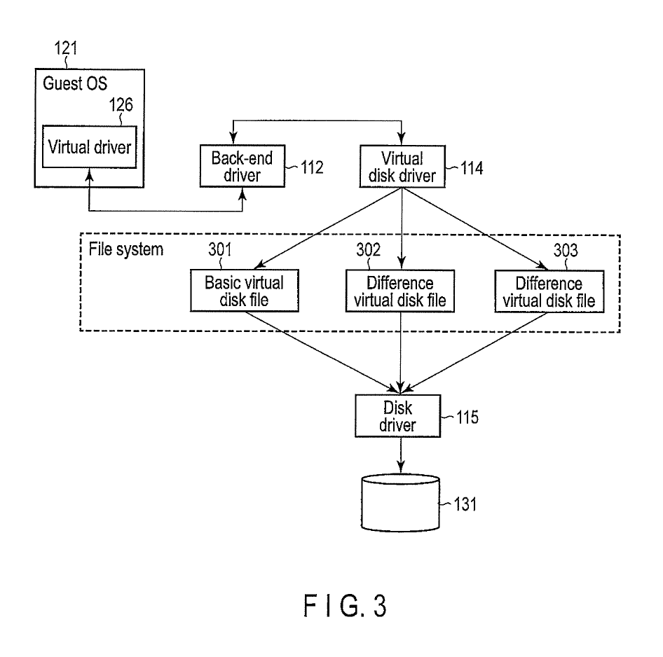

The hypervisor 101 arbitrates resource of a CPU 231, and distributes the resource of the CPU 231 as virtual CPU to the domains (virtual machine control domain and guest virtual machine), in accordance with scheduling provided by a scheduler 105. Resource of a memory 202 is assigned to operating systems of the domains by a memory manager 104 which runs in the hypervisor 101. In the case of using a graphics processing unit (GPU) 233, a USB controller (USB Cont.) 234, or devices such as audio, USB, and IEEE 1394 devices, except a disk controller 236 and a LAN controller 132, the guest OS 121 in the guest virtual machine 120 can directly access an I/O of the device by drivers 124 and 125 (pass-through method). In the case of using the disk controller 236 and the LAN controller 132, the guest OS 121 in the guest virtual machine accesses a back-end driver 112 of the virtual machine control domain 110 through a front-end virtual driver 126 (service VM method). The back-end driver 112 arbitrates access by the control domain OS 111 and access by the guest OS 121, and accesses the disk controller 236 and the LAN controller 132. Although one disk is seen from the guest OS 121 during this processing, the guest OS uses a virtual disk which is formed of a plurality of virtual disk files, as the disk (FIG. 3).

FIG. 3 is a block diagram illustrating an example of a structure of the virtual disk. For example, as illustrated in FIG. 3, the virtual disk is formed of a basic virtual disk file 301 which serves as the master (original), a system difference virtual disk file 302 which stores difference information that indicates a changed position for data indicated by the basic virtual disk file 301 and changed data, and a user difference virtual disk file 303. In the present embodiment, the difference virtual disk files are used. For example, write data is stored in the user difference virtual disk file 303.

A guest virtual machine management agent program (hereinafter referred to as management agent) 123, which runs on the guest OS 121, monitors the state of the guest virtual machine 120.

The management agent 123 communicates with a virtual machine manager (VM manager) 118 in the control domain 110, through an I/O manager 103 which runs in the hypervisor 101. The virtual machine manager 118 can issue instructions such as start, end, and return from sleep of the guest virtual machine 120, by using a control interface of the hypervisor 101. A virtual ACPI 117 of the control domain 110 does not directly control ACPI of the client computer 100, for power supply control (ACPI) from the guest OS 121. The virtual ACPI 117 runs to control power supply only in the domain of the guest virtual machine 120. For example, when the guest OS 121 is changed to a sleep state, only the guest OS 121 is changed to a sleep state, and the hypervisor 101 and the control domain OS 111 run in a normal state.

The client computer 100 has some modes (states). The following is explanation of the modes of the client computer 100.

Distribution image receiving mode: A mode of receiving the basic virtual disk file 301 and the difference virtual disk files 302 and 303 from the distribution server 202, and storing the basic virtual disk file 301 and the difference virtual disk files 302 and 303 in the storage 131 of the client computer 100.

Setup mode: A mode of starting the disk image files stored in the storage 131 as the guest OS 121, and performing setup (install and setup of the driver) to a state in which the user can perform login.

Operating mode: A state in which the user logs in and executes the guest OS 121.

User switching mode: A state in which the user account is changed, and virtual machines are switched.

Guest OS storage mode: a state of storing contents of a memory (RAM) used by the environment of the guest OS 121 in the NAS 220.

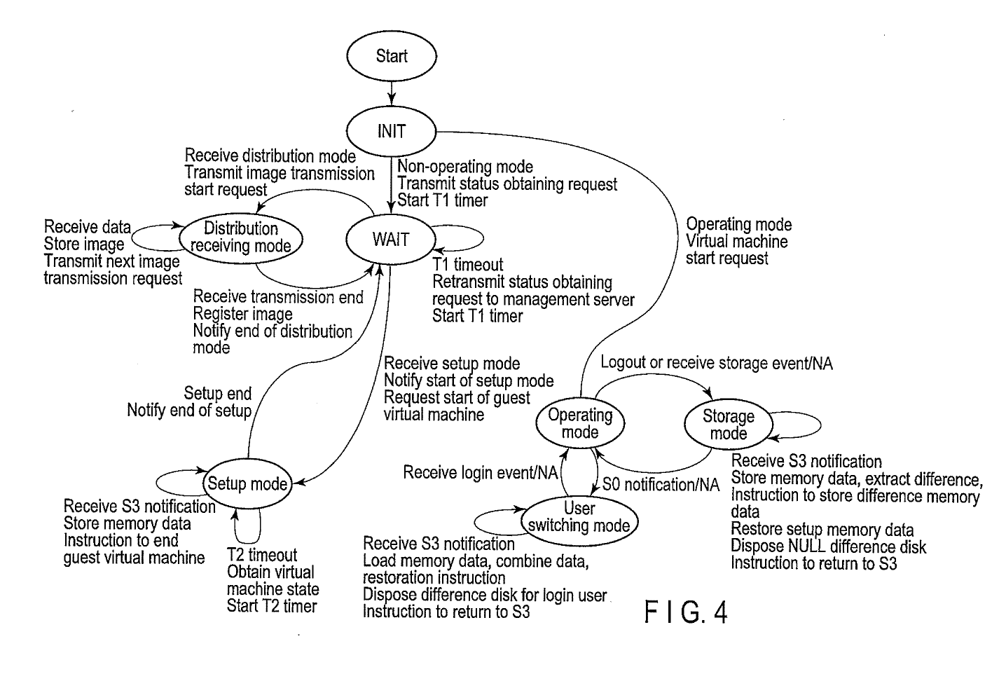

Change of the above mode is explained with reference to FIG. 4.

When the system is started, the virtual machine manager 118 changes to an initial state (INIT). When the virtual machine manager 118 receives notification of a non-operating mode, the virtual machine manager 118 changes to a wait state (WAIT). In the wait state, the virtual machine manager 118 transmits a mode checking request to the management server 201. When there is no response from the management server 201 until T1 time passes after transmission of the request, the virtual machine manager 118 transmits a mode checking request to the management server 201 again.

When the management server 201 notifies the virtual machine manager 118, in response to the mode checking request, that the computer is in the distribution receiving mode, the virtual machine manager 118 changes to “distribution receiving mode”. Then, the virtual machine manager 118 transmits an image transmission start request to the distribution server. When data is received from the distribution server, the virtual machine manager 118 stores an image file in the storage 131. If necessary, the virtual machine manager 118 transmits a request to transmit data for storing the next image file in the storage to the distribution server. When the distribution server notifies the virtual machine manager 118 that transmission is finished, the virtual machine manager 118 registers the image file in the hyper visor 101. Then, the virtual machine manager 118 notifies the management server 201 of end of the distribution receiving mode, and changes to the wait state (WAIT). The management server 201 instructs the virtual machine manager to change to the setup mode.

When the virtual machine manager receives notification of the setup mode from the management server 201, the virtual machine manager changes to the “setup mode”. The virtual machine manager 118 transmits a setup mode start notification to the management server 201. The virtual machine manager 118 issues a request to start the guest virtual machine to the hypervisor 101.

In the setup mode, the virtual machine manager 118 checks the setup state of the guest OS for each T2 time. When the virtual machine manager 118 checks that setup of the guest OS is finished, the virtual machine manager 118 notifies the management server 201 of end of the setup, and shuts down the system.

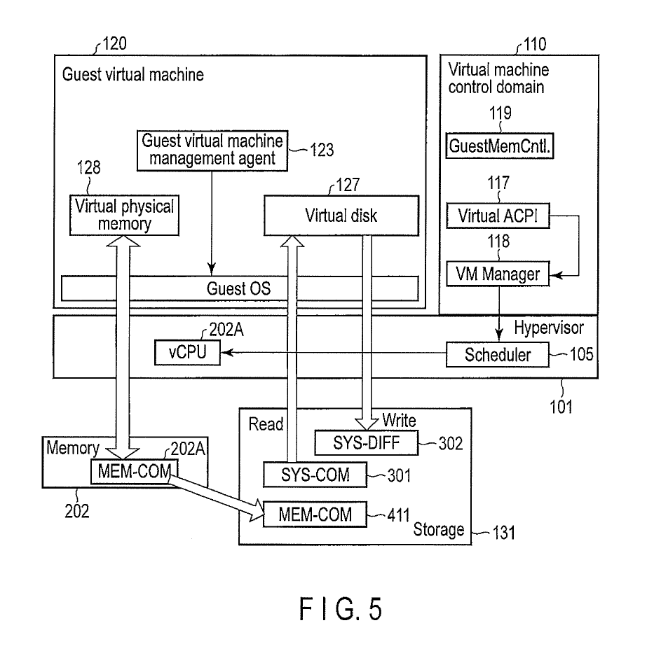

With reference to FIG. 5, processing performed in the setup mode will be explained hereinafter. The basic virtual disk file 301 is distributed from the distribution server 202 to each client computer 100. The same basic virtual disk file (SYS-COM) 301 is stored in the storage 131 of each client computer 100.

After receiving the distributed image, each client computer 100 changes to the setup mode. Each client computer 100 reads out the basic virtual disk file (SYS-COM) 301 from the storage 131, and starts the virtual machine. During this processing, an empty system difference virtual disk file (SYS-DIFF) 302 of one stage is prepared in the storage 131, and the difference virtual disk file (SYS-DIFF) 302 is put into the virtual disk 127, as well as the distributed basic virtual disk file 301. Thereby, all write operations from the guest virtual machine to the virtual disk 127 are performed for the empty system difference virtual disk file (SYS-DIFF) 302.

Since the guest OS 121 is started on the first client computer 100, install of the driver and setting of the network are performed when the guest OS 121 is started. In addition, an ID (machine name or the like) of the client is set. The system difference virtual disk file (SYS-DIFF) 302 is prepared for each client. Data used for the corresponding clients are stored in the respective system difference virtual disk files (SYS-DIFF) 302.

When setup is finished, the guest virtual machine management agent 123 recognizes that the setup is finished. The guest virtual machine management agent 123 notifies the virtual machine manager 118 of the virtual machine control domain 110 that the setup is finished. The guest virtual machine management agent 123 issues a sleep request to the guest OS 121.

The guest OS 121 includes an OS-directed power panagement (OSPM) module which is compliant with ACPI. When the guest OS 121 receives a sleep (S3: suspend to RAM) request from the guest virtual machine management agent 123, the OSPM module in the guest OS 121 changes the devices in the physical layer 230 to a D3 state (stopped state) by the device drivers which correspond to the respective devices.

When the OSPM module checks that all the devices are stopped, the OSPM module outputs an I/O to a virtual BIOS of the guest virtual machine 120 to change the system to the S3 (sleep) state. For example, by accessing a specific I/O address (for example, by issuing an output command to the specific I/O address), the OSPM module instructs the virtual BIOS to change to the S3 (sleep) state.

In a virtual environment, the I/O (for example, access to a specific I/O address) is captured by an I/O manager 103 of the hypervisor 101. The I/O manager 103 transmits the captured I/O to an I/O emulator 116 on the control domain OS 111. Since the transmitted I/O is an I/O address of ACPI, the I/O emulator 116 notifies processing of the virtual ACPI of the transmitted I/O. Then the virtual machine manager (VM manager) 118 recognizes that the guest virtual machine changes to the S3 (sleep) state, and instructs a guest memory controller (GuestMemCnt) 119 to store the data of memory (RAM) 202A which was used by the guest OS (assigned to the guest virtual machine).

The guest memory controller 119 extracts data of the memory (RAM) 202A which was used by the guest OS 121 for each page (4 KB) or each super-page (2 MB), and stores the data in the storage 131 as an image file (MEM-COM) 411. After the data is stored, the virtual machine manager 118 instructs the hypervisor 101 to end the guest virtual machine 120, shuts down the system, and thereby the setup is finished. In this processing, the virtual machine manager 118 notifies the management server 201 of end of the setup mode, and sets the computer to the operating mode.

After the user turns on the power of the client computer 100, in which the virtual environment has been set up, and starts the client computer 100 (INIT), the virtual machine manager 118 changes to the “operating mode”, when the set mode is the operating mode.

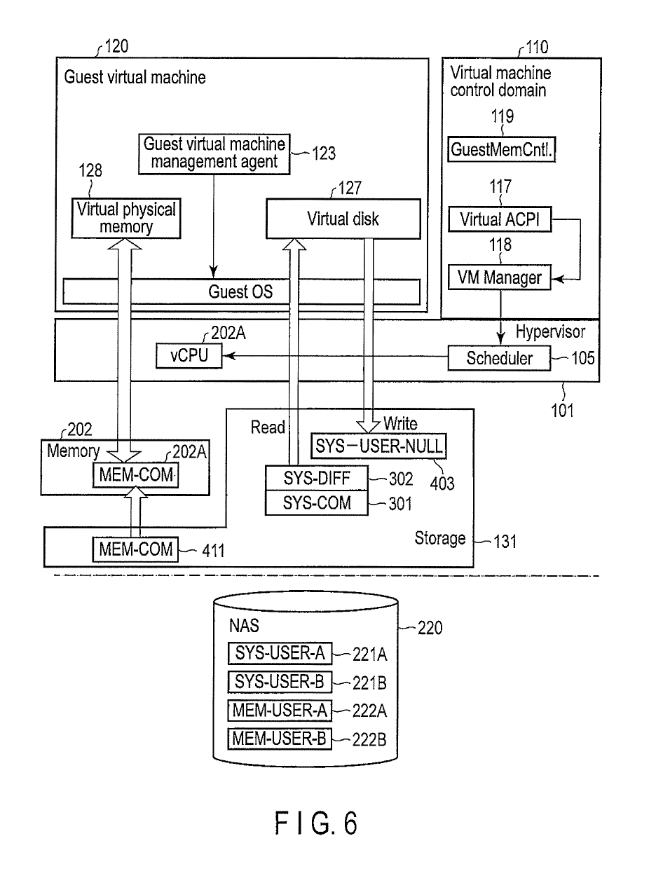

The operating mode will be explained hereinafter with reference to FIG. 6. In the operating mode, the client computer 100 starts the hypervisor 101, and starts the control domain OS 111. Then, as illustrated in FIG. 6, the virtual machine manager 118 is started on the control domain OS 111, and assigns the distributed basic virtual disk file (SYS-COM) 301 and the system difference virtual disk file (SYS-DIFF) 302 stored in setup to the hypervisor, as the virtual disk 127. Then, the virtual machine manager 118 further sets another virtual disk file (SYS-USER-NULL), in which no data is stored, in the virtual disk 127.

The virtual machine manager 118 instructs the hypervisor 101 to generate a guest domain to start the guest virtual machine. Then, the virtual machine manager 118 instructs the guest memory controller (GuestMemCntl) 119 to restore data in a guest memory (RAM) assigned to the guest virtual machine 120, based on the MEM-COM file 411 stored in setup. The hypervisor 101 maps data in the same address as the address used when the MEM-COM file 411 is stored, and assigns a storage region of the memory to the guest virtual machine as the guest memory (RAM) 202A, such that the data in the memory is available from the guest OS. The guest memory controller 119 restores data in the assigned storage region of the memory based on the MEM-COM file 411. After restoration is finished, the virtual machine manager 118 instructs the guest virtual machine to return to an S0 (powered up and operating) state.

Thereby, the guest OS 121 returns to the last state of the setup mode, and a login input picture is displayed on the screen.

The user attempts login by inputting the account ID and the password of the user. The guest OS 121 performs designated authentication based on the ID and the password input in the login, and starts login processing when they are authenticated.

The guest virtual machine management agent 123 of the guest virtual machine 120 receives the login event, transmits the user ID to the virtual machine manager 118, and instructs the guest OS 121 to directly change to the S3 (sleep) state. The guest OS 121 changes the devices to the D3 (stopped) state in the same manner as in setup, and outputs an I/O to change to the S3 (sleep) state.

When the virtual machine manager 118 receives information which indicates logout or an environment storage event from the management agent 123 in the operating mode, the virtual machine manager 118 changes to the storage mode. In the storage mode, when the client computer 100 changes to the S3 (sleep) state, data of the storage region of the memory assigned to the guest virtual machine is stored in a storage region of the storage 131, which is assigned to the virtual machine control domain 110. The virtual machine manager 118 extracts a difference between the MEM-COM file 411 and the data in the memory 202, and generates difference information which indicates the changed position and changed data. The virtual machine manager 118 stores the generated difference information in the NAS 220.

The virtual machine manager 118 obtains the SYS-USER-A file 221A from the NAS 220, and compares the difference information included in the SYS-USER-A file 221A with the difference information included in the virtual disk file (SYS-USER-NULL) 403. Then, the virtual machine manager 118 updates the SYS-USER-A file 221A, such that the SYS-USER-A file 221A includes data that includes the new changed position and changed data which are changed after the SYS-USER-A file 221A is initially prepared. Thereafter, the virtual machine manager 118 empties the virtual disk file (SYS-USER-NULL) 403. Then, the virtual machine manager 118 instructs the guest virtual machine to return to the S0 (powered up and operating) state from the S3 state. Thereafter, the virtual machine manager 118 returns to the “operating mode”.

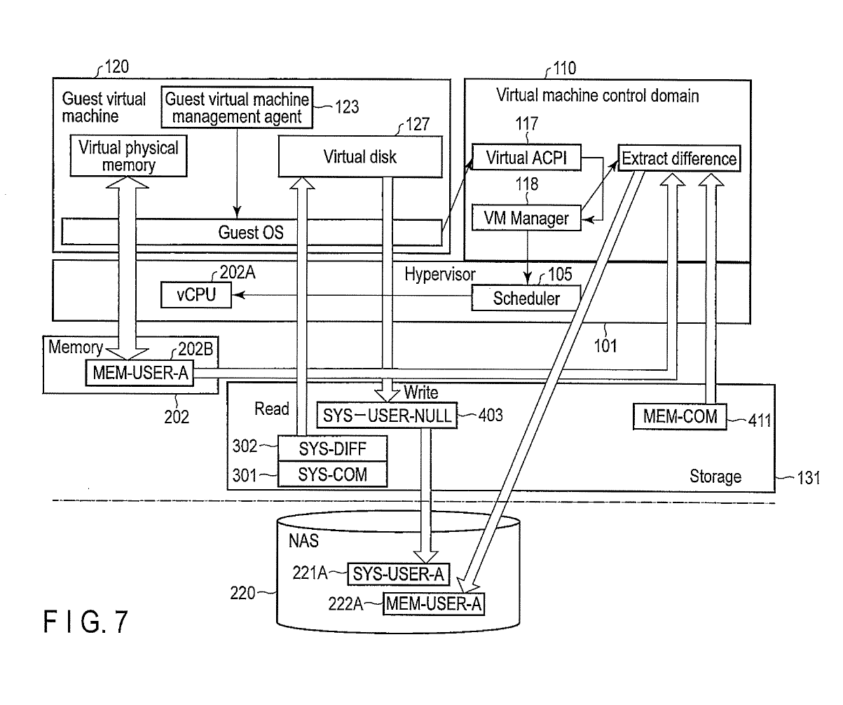

Operation performed in the storage mode will be explained hereinafter with reference to FIG. 7.

When a storage instruction or a logout instruction is detected during login, the guest virtual machine management agent 123 detects the instruction, and changes the guest domain to the S3 (sleep) state. Then, as illustrated in FIG. 7, when the guest domain changes to the S3 (sleep) state, the virtual machine manager 118 compares the current contents of the RAM (MEM-USER-A file 202B) with the contents (MEM-COM file 411) in setup, an extracts a difference between them for each page or each superpage. The virtual machine manager 118 stores difference information which indicates the changed position and changed data in the NAS 220 as MEM-USER-A file 222A, and updates the MEM-USER-A file 222A in the NAS 220. The MEM-USER-B file 222B is a file which is stored in the same manner.

The virtual machine manager 118 stores the SYS-USER-NULL file 403, which forms the virtual disk file, in the NAS 220 as SYS-USER-A file 221A, and updates the SYS-USER-A file 221A in the NAS 220.

After the SYS-USER-A file 221A and the MEM-USER-A file 222A are updated, the virtual machine manager 118 performs setting such that the difference disk file (SYS-USER-B) and the difference memory data file (MEM-USER-B) of the user can be obtained from the NAS 220 on the network, based on the user ID information.

When a login event is received from the management agent 123, the virtual machine manager 118 changes from the operating mode to the user switching mode. When the client computer 100 changes to the S3 (sleep) state, the virtual machine manager 118 receives the basic virtual disk file 301, the system difference virtual disk file 302, and the basic memory image file 411 from the distribution server 202, and receives the basic memory image file and the user difference virtual disk file which correspond to the login user from the NAS. Then, the virtual machine manager 118 restores data in the storage region of the memory 202, and stores the image file in the storage 131 of the client computer 100. Thereafter, the virtual machine manager 118 instructs the guest virtual machine 120 to return to the S0 (powered up and operating) state from the S3 state. Then, the virtual machine manager 118 returns to the “operating mode”.

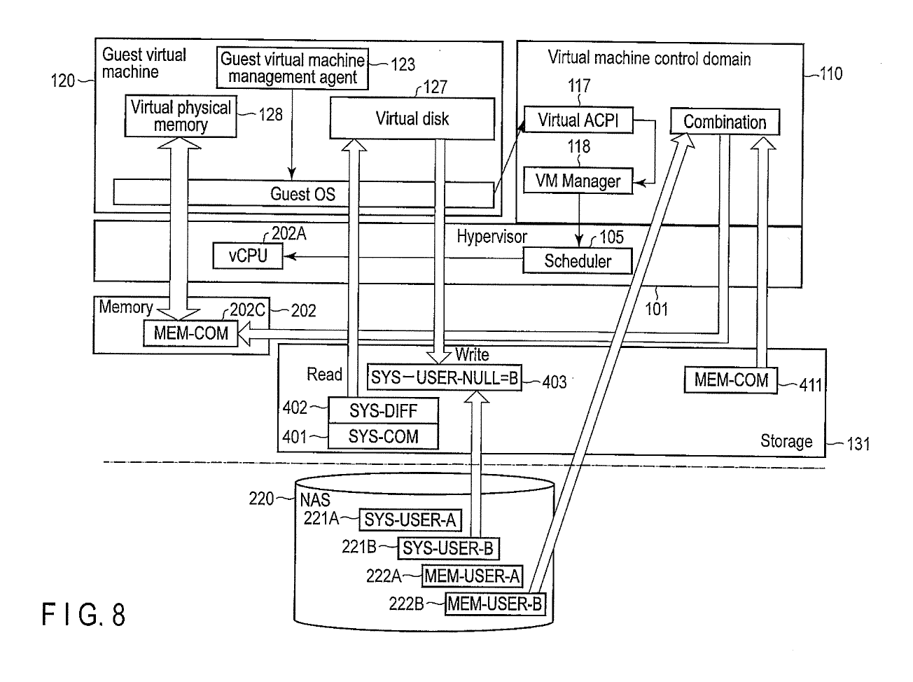

Processing performed in “user switching mode” will be explained hereinafter with reference to FIG. 8. The following is explanation of the case where the usage environment of user B is reproduced.

The virtual machine manager 118 generates data which is obtained by combining the MEM-USER-B file 222B with the MEM-COM file 411 stored in the client computer 100. The guest memory controller 119 disposes (restores) the generated data in the memory 202C assigned to the guest virtual machine 120. The SYS-USER-B file 221B is used as the SYS-USER-NULL file 403. After restoration is finished, the virtual machine manager 118 instructs the hypervisor 101 to change the domain to the S0 (resume) state, and resumes the guest OS.

After the picture is changed during login and the desktop environment of user B is displayed, user B can start operation.

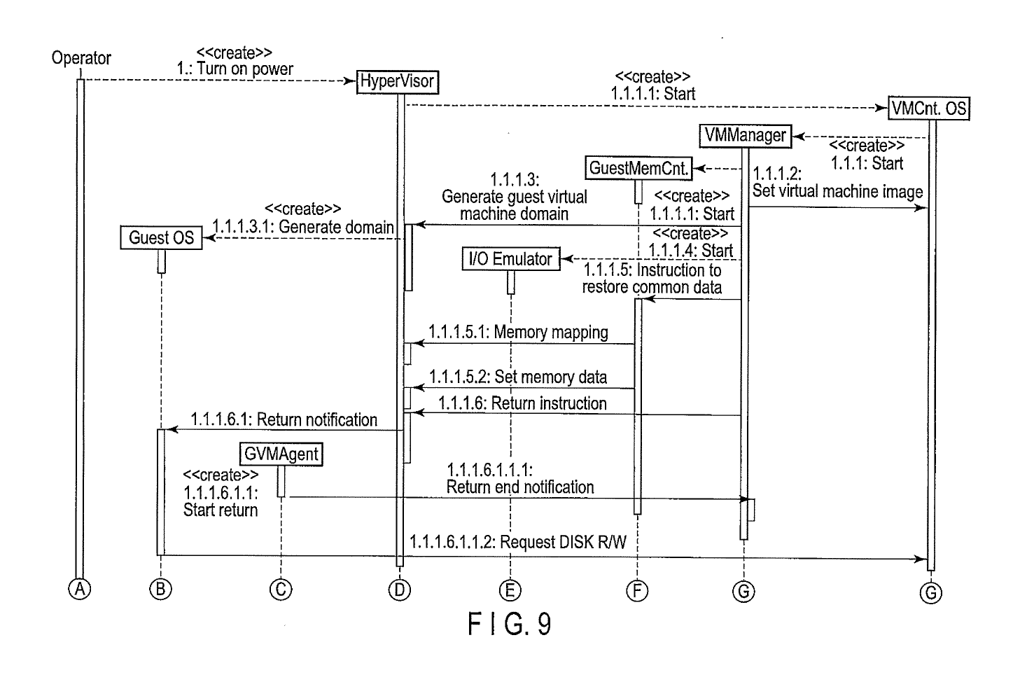

User switching operation performed after the computer starts in the operating mode will be explained with reference to sequence diagrams of FIG. 9 to FIG. 12.

In FIG. 9, when the power of the client computer 100 is turned on, the hypervisor 101 is executed. The hypervisor 101 starts the VM control domain OS 111 (1.1). The control domain OS 111 starts the virtual machine manager 118. The virtual machine manager 118 starts the guest memory controller 119 (1.1.1). The virtual machine manager 118 refers to the basic virtual disk file 301 and the system difference virtual disk file 302 in the storage 131, and sets a virtual disk which is formed of the basic virtual disk file 301 and the system difference virtual disk file 302 in the control domain OS 111 (1.1.1.2). The virtual machine manager 118 instructs the hypervisor 101 to generate a domain to execute a virtual machine (1.1.1.3). The hypervisor 101 generates a domain (1.1.1.3.1).

The virtual machine manager 118 starts the I/O emulator 116 (1.1.1.4). The virtual machine manager 118 instructs the guest memory controller 119 to restore common data in the memory 202. The guest memory controller 119 maps the same logical address as the address used when the MEM-COM file 411 is stored, for a logical address of a table of converting physical addresses of the memory 119 into logical addresses of the virtual memory managed by the virtual machine, which is managed by the hypervisor 101 (1.1.1.5.1). The guest memory controller 119 stores data in the memory 202, based on the MEM-COM file 411 (1.1.1.5.2).

The virtual machine manager 118 instructs the hypervisor 101 to return to the S0 state (1.1.1.6). The hypervisor 101 instructs the guest OS 121 to return to the S0 state (1.1.1.6.1). The guest OS 121 starts processing of returning to the S0 state. When the guest OS returns to the S3 state, the management agent 123 notifies the virtual machine manager 118 that the return processing is finished (1.1.1.6.1.1.1.). When the guest OS 121 accesses the storage 131, the guest OS 121 issues an access request to the back-end driver 112 of the VM control domain OS 111 (1.1.1.6.1.1.2). By the processing described above, the computer changes to the state illustrated in FIG. 6.

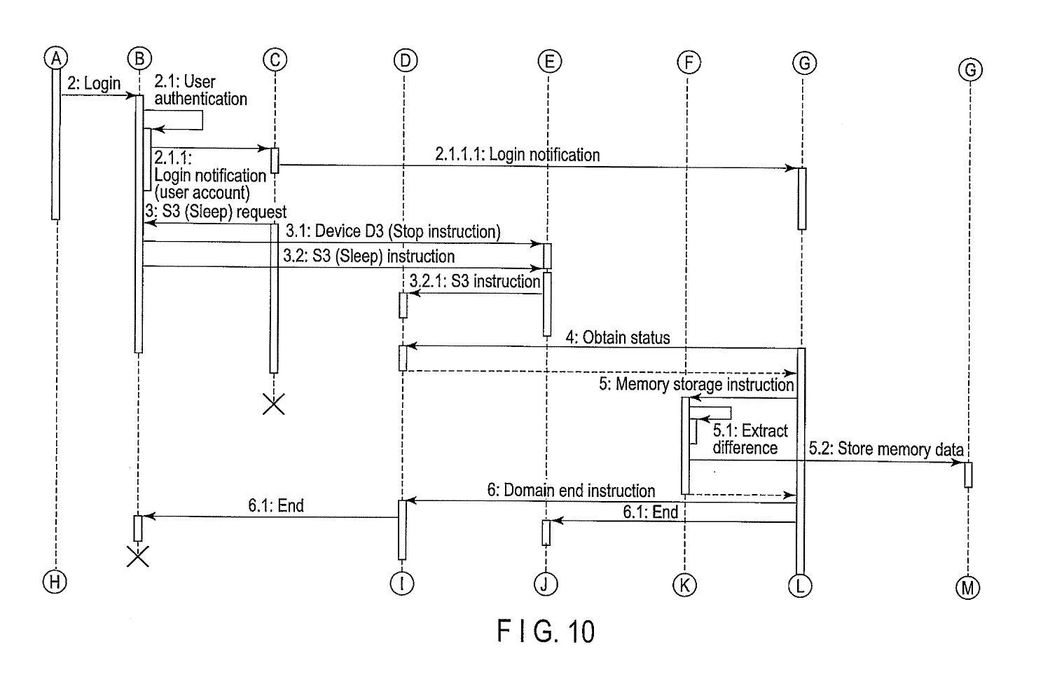

In FIG. 10, when the operator performs login (2), the guest OS 121 performs user authentication (2.1). The guest OS 121 notifies the management agent 123 that the login event is received (2.1.1). The management agent 123 requests the guest OS 121 to change to the S2 state (3). The OSPM module of the guest OS 121 instructs the I/O devices which perform pass-through and the I/O emulator 116 to change to the D3 state.

When the OSPM module of the guest OS 121 checks that all the devices change to the stopped state, the OSPM module outputs an I/O to the virtual BIOS to change the system to the S3 state. An output from the guest OS 121 to the I/O is captured by the I/O emulator 116 (3.2). The I/O emulator 116 instructs the hypervisor 101 to change the domain, in which the guest OS 121 runs, to the S3 state (3.2.1).

The virtual machine manager 118 obtains the state of the domain (4). When the domain changes to the S3 state, the virtual machine manager 118 instructs the guest memory controller to store data which is stored in the storage region of the memory that is assigned to the virtual machine in which the guest OS ran (5). As explained above with reference to FIG. 7, the guest memory controller extracts a difference between the data stored in the storage region of the memory assigned to the virtual machine with data indicated by the MEM-COM file 411 (5.1). Difference information which indicates the extracted difference data and a storage position of the difference data is stored in, for example, the NAS 220 (5.2).

The virtual machine manager 118 instructs the hypervisor 101 to end the domain (6). The hypervisor 101 ends the domain (6.1). The virtual machine manager 118 ends the I/O emulator 116 (7).

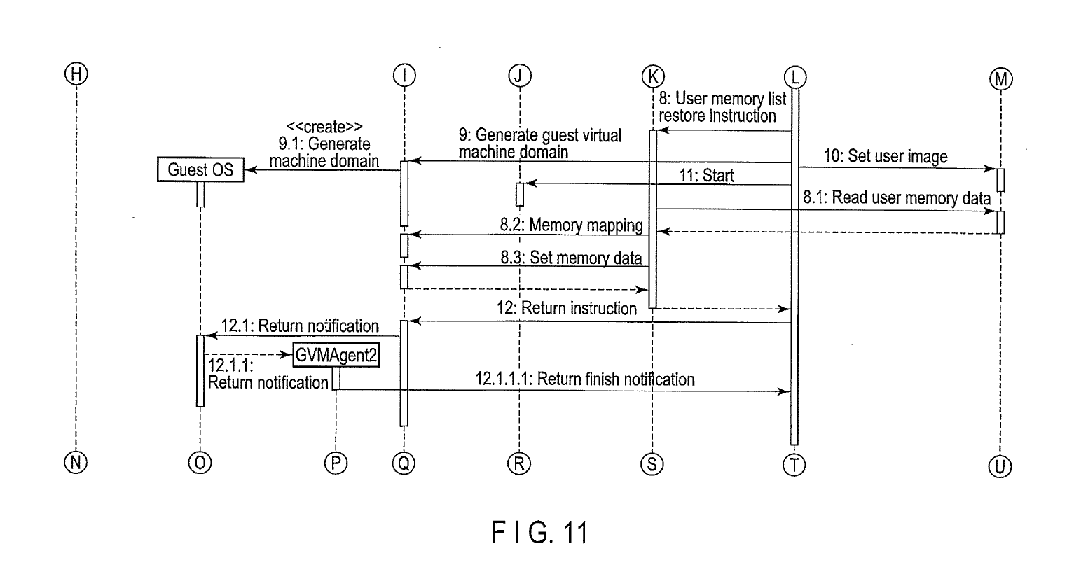

In FIG. 11, the virtual machine manager 118 instructs the guest memory controller to restore data in the memory by using the MEM-COM file 411 and the MEM-USER file which corresponds to the login user (8).

The virtual machine manager 118 instructs the hypervisor 101 to generate a domain to execute the virtual machine (9). The hypervisor 101 generates a domain (9.1).

As explained above with reference to FIG. 8, the virtual machine manager 118 sets a virtual disk to execute the guest virtual machine in the hypervisor, based on the basic virtual disk file 301, the system difference virtual disk file (SYS-DIFF) 302, and the user difference virtual disk file (SYS-USER file) 303, and starts the guest virtual machine (10). The virtual machine manager 118 starts the I/O emulator 116 (11).

The guest memory controller 119 issues a request to read the MEM-COM file 411 and the MEM-USER file which corresponds to the login user to the VM control domain OS 111 (8.1). The guest memory controller maps the same logical address as the address used when the MEM-COM file was stored, for the logical address of a table of converting the physical addresses of the memory into the logical addresses of the virtual memory managed by the virtual machine, which is managed by the hypervisor 101 (8.2). The guest memory controller stores data in the memory 202, based on the MEM-COM file 411 and the MEM-USER file (8.3).

The virtual machine manager 118 instructs the hypervisor 101 to return the operating system to the S0 state (12). The hypervisor 101 instructs the guest OS 121 to return to the S0 state (12.1). The guest OS 121 starts processing of returning to the S0 state (12.1.1). When the guest OS 121 returns to the S3 state, the management agent 123 notifies the virtual machine manager 118 that the return processing is finished (12.1.1.1).

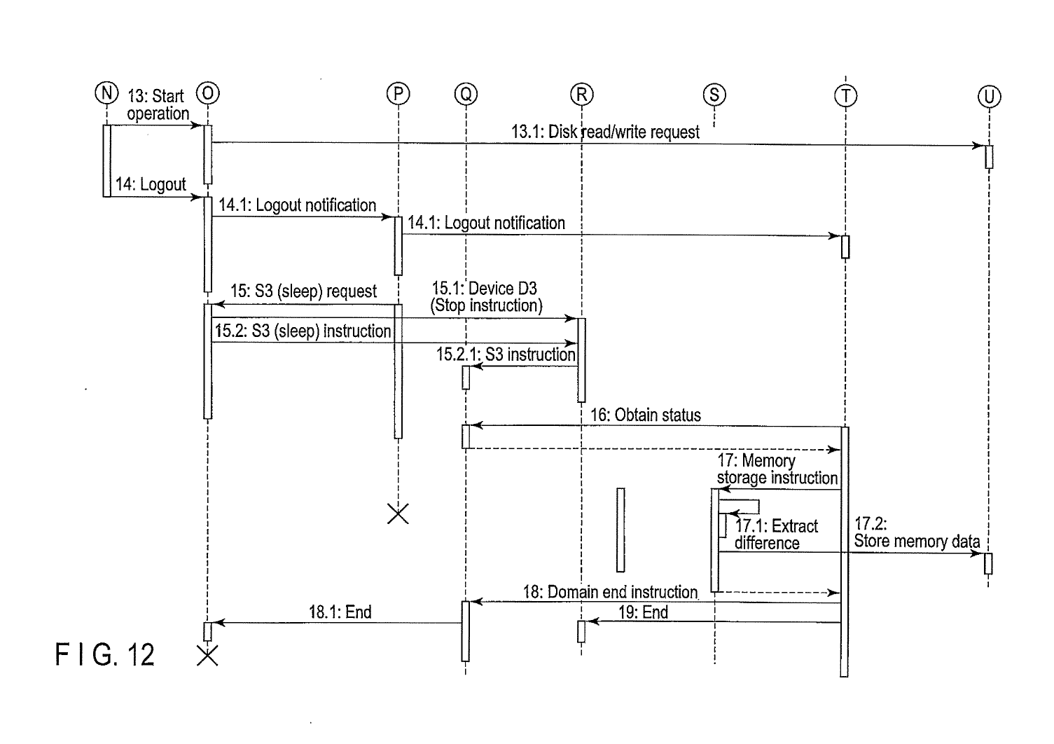

In FIG. 12, when the guest OS 121 returns to the S0 state, the operator starts operation (13). When the guest OS accesses the storage, the guest OS issues an access request to the back-end driver on the VM control domain OS 111 (13.1).

When the operator performs a logout operation (14), the guest OS 121 transmits a logout event to the management agent 123. The management agent 123 notifies the virtual machine manager 118 of reception of the logout event.

The management agent 123 requests the guest OS to change to the S3 state (15). The guest OS instructs the I/O emulator 116 to change the devices to the D3 state (15.1).

When the guest OS 121 checks that all the devices are changed to the stopped state, the guest OS 121 outputs an I/O to the virtual BIOS to change the system to the S3 state. The output from the guest OS to the I/O is captured by the I/O emulator 116 (15.2). The I/O emulator 116 instructs the hypervisor 101 to change the domain (guest virtual machine), in which the guest OS runs, to the S3 state (15.2.1).

The virtual machine manager 118 obtains the state of the domain (16). When the domain changes to the S3 state, the virtual machine manager 118 instructs the guest memory controller to store data which is stored in the storage region of the memory assigned to the virtual machine in which the guest OS 121 ran (17). The guest memory controller 119 extracts a difference between the data stored in the storage region of the memory assigned to the virtual machine and the data indicated by the MEM-COM file (17.1). The guest memory controller 119 updates the MEM-USER file based on the extracted difference data (17.2).

The virtual machine manager 118 instructs the hypervisor 101 to end the domain (18). The hypervisor 101 ends the domain, in accordance with the instruction from the virtual machine manager 118 (18.1). Then, the virtual machine manager 118 ends the I/O emulator 116 (19).

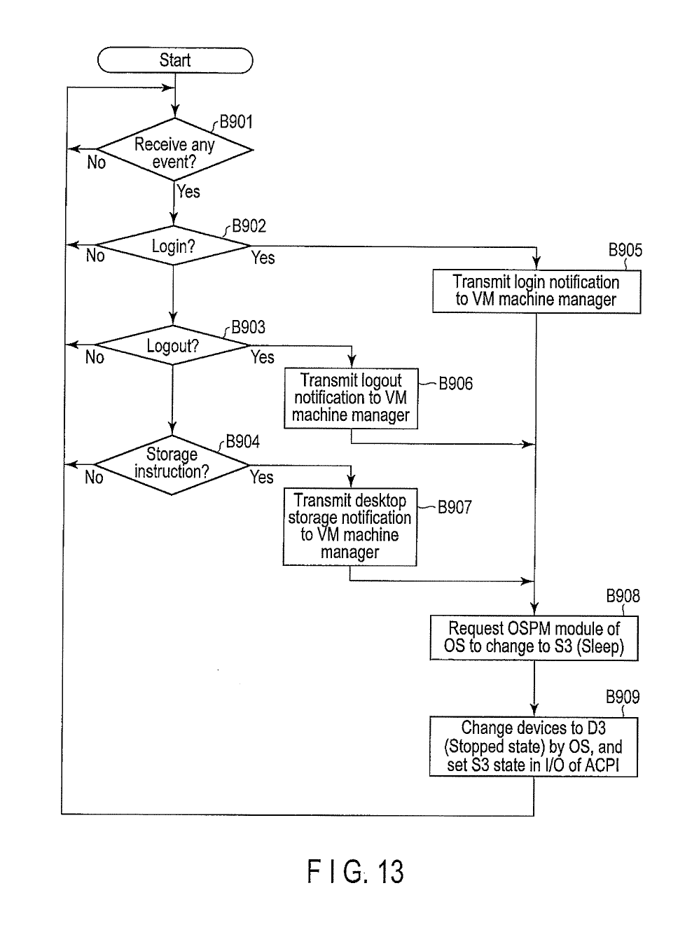

Next, operation of the management agent 123 in the operating mode will be explained hereinafter with reference to a flowchart of FIG. 13.

The management agent 123 waits for an event from the guest OS (Step B901). When the management agent 123 receives an event, the management agent 123 determines whether the received event is a login event or not (Step B902). When it is determined that the event is a login event (Yes in Step B902), the management agent 123 notifies the virtual machine manager 118 that a login event is received (Step B905). When it is determined that the event is not a login event (No in Step B902), the management agent 123 determines whether the received event is a logout event or not (Step B903). When it is determined that the event is a logout event (Yes in Step B903), the management agent 123 notifies the virtual machine manager 118 that a logout event is received (Step B906). When it is determined that the event is not a logout event (No in Step B903), the management agent 123 determines whether the received event is a desktop environment storage instruction event or not (Step B904). When it is determined that the event is a desktop environment storage instruction event (Yes in Step B904), the management agent 123 notifies the virtual machine manager 118 that a desktop environment storage instruction event is received (Step B907). After Step B905, B906, or B907, the management agent 123 request the OSPM module of the operating system to change to the S3 state (Step B908). The operating system changes the devices to the D3 state, and sets the S3 state in the I/O of the ACPI (Step B909).

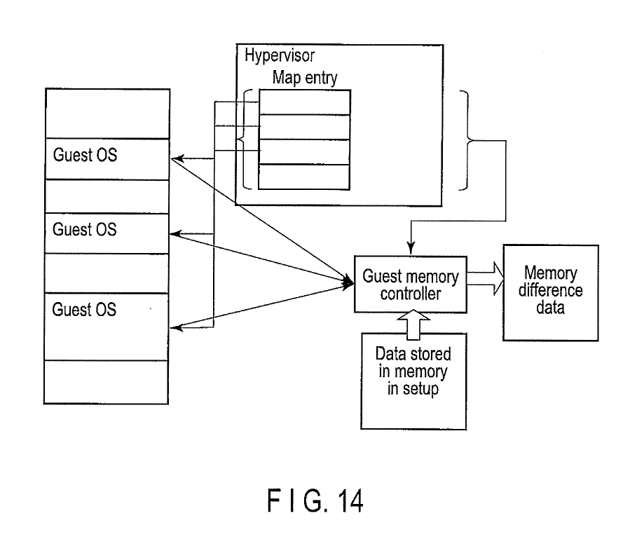

FIG. 14 is a diagram for explaining preparation of difference data of the memory. When there is only one guest virtual machine (excluding the control domain OS 111), the memory region used by the guest virtual machine is equal to the memory region used in setup. The hypervisor 101 includes mapping information (physical address and size) of each block of the divided memory region. Since the state of the mapping information after user login is the same as that when the setup was performed, it is possible to obtain a difference. Generally, there are a memory storage region which is fixedly used by the guest OS, and a memory storage region which is dynamically used by applications. Usually the contents of the storage region which is fixedly used do not change. Therefore, the stored memory quantity is reduced by obtaining a difference in setup of the regions.

According to the above embodiment, when logout is requested of the guest OS which runs in the guest virtual machine, the guest OS is requested to change from the normal state to the sleep state. When the guest OS changes to the sleep state, a memory image file which indicates data in the storage region of the memory used by the guest OS is prepared. Then, when it is requested to start the guest virtual machine, the disk image file which indicates data in the storage region of the storage device which was assigned to the virtual machine when the memory image file was prepared is set in the hypervisor, and data stored in the first storage region is restored in the second storage region of the memory assigned to the virtual machine, based on the memory image file. When the data is restored in the second storage region, the hypervisor is requested to return the operating system from the sleep state to the normal state. Thereby, it is possible to shorten the wait time required until the guest virtual machine becomes available, when the guest virtual machine is started or the login user is changed.

Although the user data during operation and the environment are stored in the above embodiment, it is possible to maintain the state of the guest virtual machine, by always restoring the disk image and the memory data stored in setup, instead of storing them.

It is possible to return the data, without restarting the computer, in use in which it is not required to store data, such as client computers used in school, and computers used by unspecified people.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a memory; and
a controller configured to control an operation environment of a virtual machine which runs on a hypervisor,
the controller comprising:
a change module configured to change the virtual machine from an operating state to a sleep state, in response to a logout request for an operating system in the virtual machine;
a storing module configured to store first image data indicating contents of the memory used by the operating system in a nonvolatile storage device as an operation environment corresponding to a first user who logged into the operating system;
a restoration module configured to restore the contents of the memory to contents based on second image data indicating a second operation environment corresponding to a second user, the second image data being stored in the nonvolatile storage device, when there is a user change request from the first user to the second user; and
a return module configured to return the virtual machine to the operating state after the contents of the memory is restored to the contents based on the second image data.

2. The apparatus of claim 1, wherein
the first image data comprises basic image data, and a difference image file comprising difference information indicating a changed position of data for contents indicated by the basic image data and changed data, and
the storing module is configured to update the difference image file when the first image data is stored.

3. The apparatus of claim 2, wherein
the change module is configured to change the virtual machine from the operating state to the sleep state, in response to the logout request for the operating system in the virtual machine, when the second operation environment operates, and
the storing module is configured to store the second image data indicating contents of the memory used by the operating system in the nonvolatile storage device as the operation environment corresponding to the second user.

4. The apparatus of claim 3, wherein
the second image data comprises the basic image data, and second difference image data comprising difference information indicating a changed position of data for contents indicated by the basic image data and changed data, and
the storing module is configured to update the second difference image data when the second image data is stored.

5. The apparatus of claim 1, further comprising:
a storage device;
a second storing module configured to store first storage image data that is stored in the storage device and indicates contents of storage data to execute the virtual machine in the nonvolatile storage device as the operation environment corresponding to the first user who logged into the operating system, when the virtual machine changes to the sleep state; and
a second restoration module is configured to restore second storage image data, which is stored in the nonvolatile storage device and indicates the operation environment corresponding to the second user, in the storage device, when there is a request to switch the user who uses the operating system from the first user to the second user.

6. The apparatus of claim 1, wherein
the first storage image data comprises a basic virtual storage file and a difference virtual storage file comprising difference information indicating a changed position of data for contents indicated by the basic virtual storage file and changed data, and
the storing module is configured to update the difference virtual storage file when the first storage image data is stored.

7. The apparatus of claim 6, wherein
the change module is configured to change the virtual machine from the operating state to the sleep state, in response to the logout request for the operating system in the virtual machine, when the second operation environment operates, and
the second storing module is configured to store the second storage image data indicating contents of the storage data in the nonvolatile storage device as the operation environment corresponding to the second user.

8. The apparatus of claim 6, wherein
the second storage image data comprises a basic virtual storage file, and a second difference virtual storage file comprising difference information indicating a changed position of data for contents indicated by the basic virtual storage file and changed data, and
the storing module is configured to update the second difference virtual storage file, when the second storage image data is stored.

9. The apparatus of claim 1, further comprising:
devices comprising a first controller configured to communicate with the storage device and a second controller configured to communicate with a device on a network,
wherein the operating system is configured to access to a device in the devices excluding the first controller and the second controller, by a pass-through model.

10. A method of controlling a virtual machine which runs on a hypervisor, the method comprising:
changing the virtual machine from an operating state to a sleep state, in response to a logout request for an operating system in the virtual machine;
storing first image data indicating contents of a memory used by the operating system in a nonvolatile storage device as an operation environment corresponding to a first user who logged into the operating system;
restoring the contents of the memory to contents based on second image data indicating a second operation environment corresponding to the second user, the second image data being stored in the nonvolatile storage device, when there is a request to switch the user who uses the operating system from the first user to the second user; and
returning the virtual machine to the operating state after the contents of the memory is restored to the contents based on the second image data.
